(19) United States
(12) Patent Application Publication
(10) Pub. No.: US 2025/0093965 A1
(43) Pub. Date: Mar. 20, 2025

(54) USER INPUT DEVICE

(71) Applicant: Cirrus Logic International Semiconductor Ltd., Edinburgh (GB)

(72) Inventors: Thomas LORENZ, Austin, TX (US); Anthony S. DOY, Austin, TX (US); Nathan A. JOHANNINGSMEIER, Austin, TX (US)

(73) Assignee: Cirrus Logic International Semiconductor Ltd., Edinburgh (GB)

(21) Appl. No.: 18/968,361

(22) Filed: Dec. 4, 2024

Related U.S. Application Data
(63) Continuation of application No. 17/983,959, filed on Nov. 9, 2022.
(60) Provisional application No. 63/278,249, filed on Nov. 11, 2021.

(30) Foreign Application Priority Data
Dec. 7, 2021 (GB) 2117647.4

(51) Int. Cl. G06F 3/02; G06F 3/01; G06F 3/0354; G06F 3/041

(52) U.S. Cl. CPC G06F 3/0202; G06F 3/016; G06F 3/03547; G06F 3/0414; G06F 2203/04105

(57) ABSTRACT

A solid state keyboard device comprising a user interaction layer for receiving a user input and a plurality of haptic actuators, wherein the solid state keyboard device is operable to cause one or more of the plurality of haptic actuators to generate a haptic output at the user interaction layer in response to a received user input, wherein one or more parameters of the haptic output are variable according to one or more parameters of or associated with the received user input.

### FIELD OF THE INVENTION

The present disclosure relates to a user input device. In particular, the present disclosure relates to a solid state keyboard for use as a user input device.

### BACKGROUND

User interactions with computing devices such as desktop and laptop computers are typically performed using a user input device such as a keyboard, mouse or touch-sensitive device such as a trackpad, touch panel, touchscreen or the like. Such user input devices may also be used as accessories for smaller form-factor computing devices such as tablet computers and smartphones, to provide alternatives to the computing device's inbuilt user input device, which is typically a touchscreen.

Historically keyboards have comprised a plurality of separate keys, each associated with a mechanism for actuating a switch when depressed by a user's finger. More recently, “virtual keyboards” have been implemented using touch-sensitive or force-sensitive user input surfaces. Such virtual keyboards typically display a graphic of a keyboard on the touch-sensitive or force-sensitive surface and detect user touches (e.g. with a finger or stylus) on regions of the touch-sensitive or force-sensitive surface at positions corresponding to the position of keys of the displayed keyboard graphic. The detected touches are translated by software into keystrokes or combinations of keystrokes.

One disadvantage of virtual keyboards is that, because they do not include any moving parts, the user receives no tactile feedback following a touch on the keyboard. This lack of tactile feedback may make it difficult for a user to use a virtual keyboard as efficiently as a mechanical keyboard, because, for example, the user may need to look at the virtual keyboard or an associated visual display for visual confirmation that a desired virtual key has been pressed.

### SUMMARY

According to a first aspect, the invention provides a solid state keyboard device comprising:
a user interaction layer for receiving a user input; and
a plurality of haptic actuators,
wherein the solid state keyboard device is operable to cause one or more of the plurality of haptic actuators to generate a haptic output at the user interaction layer in response to a received user input, wherein one or more parameters of the haptic output are variable according to one or more parameters of or associated with the received user input.

The one or more parameters of or associated with the user input may comprise one or more of:
one or more positions of the user input on the user interaction layer;
a pressure of the user input;
a speed of the user input;
a duration of the user input; and
a duration of a user input session.

The one or more parameters of the haptic output may comprise one or more of:
an amplitude;
a frequency;
a duration; and
a duty cycle.

The haptic actuators may comprise piezoelectric actuators and/or electrostatic actuators.

The haptic actuators may be configured to generate an electrical signal in response to a user input.

The user interaction layer may comprise a substantially continuous layer.

The user interaction layer may comprise a plurality of individual portions.

Each individual portion may be associated with one or more of the plurality of haptic actuators.

Each individual portion may be associated with a respective one of the plurality of haptic actuators.

The user interaction layer may comprise a touch-sensitive or force-sensitive layer.

The solid state keyboard device may further comprise user input detection circuitry configured to determine the one or more parameters of or associated with the user input.

The solid state keyboard device may further comprise processing circuitry configured to process a signal output by the user input detection circuitry to determine, based on the signal output by the user input detection circuitry, a nature of a detected user input.

The solid state keyboard device may further comprise haptic output generation circuitry configured to generate a haptic output signal or to retrieve a predefined haptic output signal for output to a first set of one or more of the plurality of haptic actuators, based on a signal output by the processing circuitry.

The haptic output generation circuitry may be further configured to generate an audio output signal or to retrieve a predefined audio output signal for output to a second set of one or more of the plurality of haptic actuators, different than the first set, based on a signal output by the processing circuitry.

The solid state keyboard device may further comprise memory for storing haptic output signals and/or audio output signals.

The solid state keyboard device may be operative to monitor or record a user's interactions with the user input device over a predetermined period of time to develop a profile for the user.

The solid state keyboard device may be configured to adjust, over a period of time, a parameter of a haptic output generated by one or more of the plurality of haptic actuators in response to a given user input.

The solid state keyboard device may be configured to reduce an amplitude of the haptic output from a first, relatively higher level, to a final, relatively lower level, over the period of time.

The solid state keyboard device may be operable to cause one or more of the plurality of haptic actuators to generate a haptic output at the user interaction layer in response to an alert, warning or error condition of a host device incorporating or using the solid state keyboard device.

One or more parameters of the haptic output may be variable according to the alert, warning or error condition of the host device.

The one or more parameters of the haptic output may comprise one or more of:
an amplitude;
a frequency;
a duration; and
a duty cycle.

According to a second aspect, the invention provides a user input device comprising:
a plurality of input/output transducers configured to receive user inputs and provide haptic outputs; and
circuitry configured to detect a user input on one or more of the input/output transducers and to generate, responsive to the detected user input, a haptic output using one or more of the input/output transducers.

According to a third aspect, the invention provides a user input device comprising:
a user interaction layer for receiving a user input; and
a plurality of input/output actuators,
wherein the user input device is operable to cause one or more of the plurality of input/output actuators to generate an audible output in response to a received user input or an alert, warning or error of a host device incorporating or using the user input device.

The user input device may comprise a keyboard or keypad.

According to a fourth aspect, the invention provides a keyboard comprising:
a plurality of transducers, each of the plurality of transducers being associated with a respective key of the keyboard; and
circuitry configured to:
   detect a user input on the keyboard; and
   responsive to the detected user input, actuate one or more of the transducers to generate a haptic output.

According to a fifth aspect, the invention provides a solid state keyboard device for use with a host device, the solid state keyboard device comprising an input/output transducer, wherein the solid state keyboard device is configured to output a haptic output signal to the input/output transducer in response to a warning, alert or error condition of the host device.

According to a sixth aspect, the invention provides a solid state keyboard device comprising:
a user interaction layer for receiving a user input; and
a plurality of haptic actuators,
wherein the solid state keyboard device is operable to cause one or more of the plurality of haptic actuators to vibrate at a predetermined frequency or frequency range in order to displace debris or liquid that is present on the user interaction layer.

According to a seventh aspect, the invention provides a solid state keyboard device comprising:
a user interaction layer for receiving a user input; and
a plurality of haptic actuators,
wherein the plurality of haptic actuators is operable as an ultrasonic sensor and/or transmitter array.

According to an eighth aspect, the invention provides a host device comprising a solid state keyboard device according to the first or fifth to seventh aspects, a user input device according to the second or third aspect, or a keyboard according to the fourth aspect.

The host device may comprise a laptop, notebook, netbook or tablet computer, a mobile telephone, a portable device, or an accessory device for use with a laptop, notebook, netbook or tablet computer, a mobile telephone, or a portable device.

### BRIEF DESCRIPTION OF THE DRAWINGS

Embodiments of the invention will now be described, strictly by way of example only, with reference to the accompanying drawings, of which:

FIG. 1 illustrates an example key configuration for a keyboard;

FIG. 2a is a schematic cross-sectional representation of a user input device according to the present disclosure;

FIG. 2b illustrates an example configuration of actuators and user interaction layer portions for the user input device of FIG. 2a; and

FIG. 2c illustrates an alternative example configuration of actuators and user interaction layer portions for the user input device of FIG. 2a.

### DETAILED DESCRIPTION

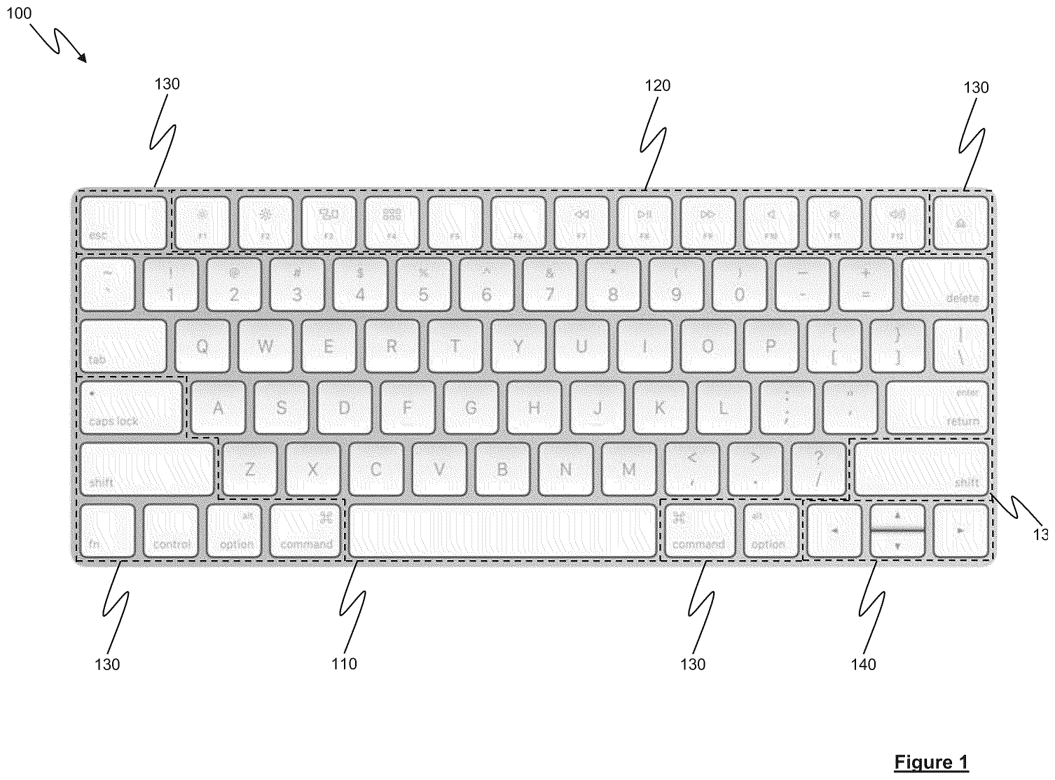

Referring first to FIG. 1, an example key configuration for a keyboard is shown generally at 100. As can be seen, the key configuration in this example includes first, second, third and fourth sets of keys 110-140.

The first set of keys 110 comprises typing keys which, when actuated, invoke commonly used typing functions such as selecting glyphs including alphanumeric characters and other characters or symbols, or deleting a glyph, character or symbol.

The second set of keys 120 comprises function keys which, when actuated, invoke particular functions of an application that is currently executing on a device incorporating or using the keyboard 100. For example, in some applications actuating a first function key may invoke a help function, actuating a second function key may invoke a save function etc.

The third set of keys 130 comprises modifier keys which, when actuated, modify the function invoked when another key (e.g. a key of the first or second set 110, 120) is actuated simultaneously or subsequently. For example, a shift key of the third set may be used to switch from selecting lower-case characters to selecting upper-case characters when a key of the first set 110 is actuated.

The fourth set of keys 140 comprise directional input keys which, when actuated, invoke a direction-related function, e.g. to move an on-screen cursor in the direction indicated by the key.

The configuration shown in FIG. 1 may be employed in a conventional mechanical keyboard, or may be implemented as a graphical display for a virtual keyboard.

As described above, virtual keyboards which use a touch-sensitive or force-sensitive surface to detect user inputs do not include any moving parts, and so may not provide tactile feedback to a user in response to a user input such as a touch or press on a region of the touch-sensitive or force sensitive surface corresponding to a key of the virtual keyboard.

In some virtual keyboard applications, a haptic feedback mechanism of a host device such as a mobile telephone or tablet computer can be enabled to provide a degree of tactile feedback in response to a user input such as a keypress. In such applications the strength of the feedback provided is uniform regardless of, for example, the pressure or speed of the user input.

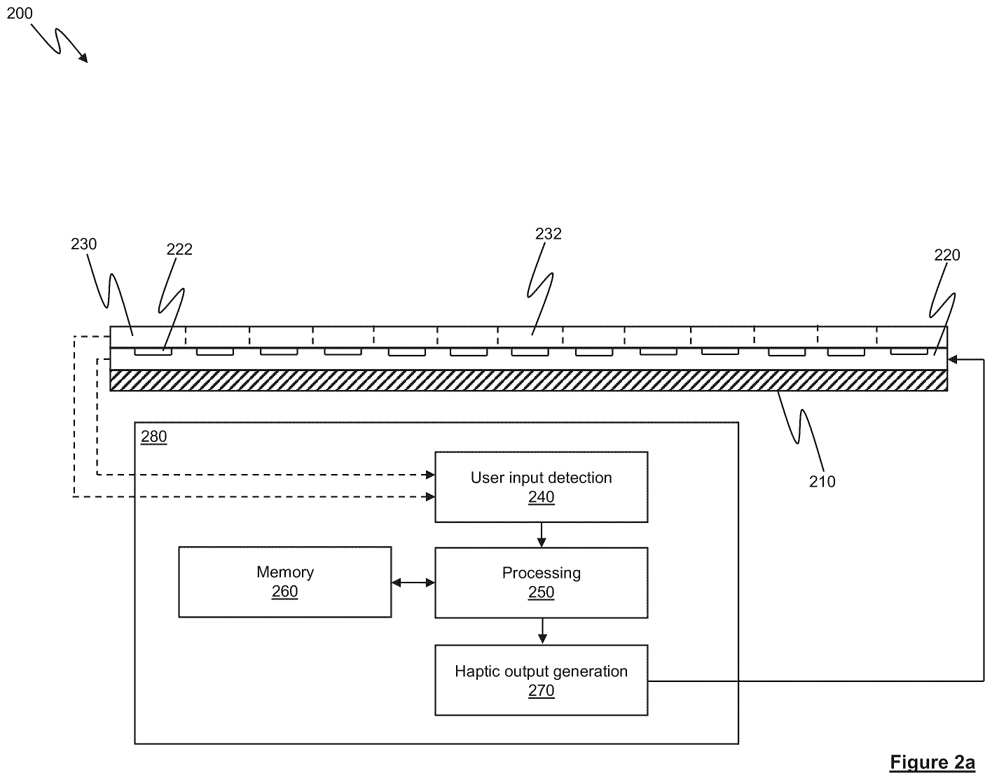

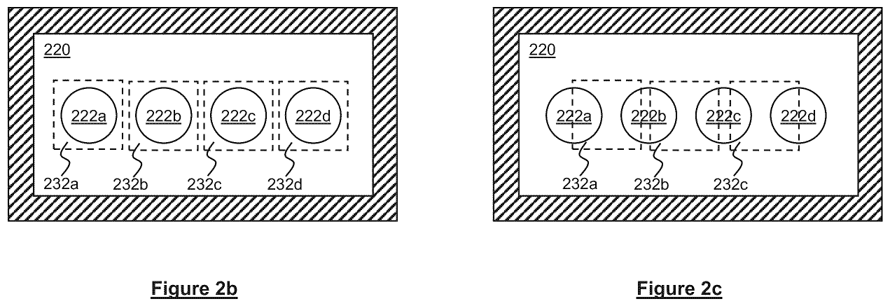

FIG. 2a is a schematic cross-sectional representation of a user interface device according to the present disclosure.

The user input device, which in this example is a keyboard device, is shown generally at 200 in FIG. 2, and comprises a first, substrate, layer 210, a second, actuator, layer 220, a third, user interaction, layer 230, as well as user input detection circuitry 240, processing circuitry 250, memory 260 and haptic output generation circuitry 270. Unlike a conventional mechanical keyboard, the user input device 200 does not include any moving parts for detecting or receiving a user input. Instead, user inputs are detected based on one or more electrical parameters of the user input device 200, and so the user input device 200 may be regarded as a solid state user input device, which in this example is a solid state keyboard device.

The first, substrate, layer 210 is configured to support the second, actuator, layer 220, and thus may be of a substantially rigid material. For example, the first, substrate, layer 210 may comprise a layer of printed circuit board (PCB) material such as FR4.

The second, actuator, layer 220 is disposed on the substrate layer 210, and comprises a plurality of haptic actuators 222, which may be, for example, electrostatic actuators or piezoelectric actuators. The plurality of haptic actuators 222 are configured to provide haptic outputs to communicate information to a user of the device 200. Thus the plurality of haptic actuators 222 are configured to act as output actuators. In some examples the haptic actuators are also configured to act as input sensors for detecting user inputs on the user input device 200, i.e. the plurality of haptic actuators are combined input/output actuators or transducers. In such examples the haptic actuators are configured to generate an electrical output signal in response to a user input.

The third, user interaction, layer 230 is provided on the actuator layer 220, and provides a surface with which a user of the device 200 can interact though physical touches, presses, gestures and the like, performed using a finger, stylus or other implement, to provide user inputs to the device 200.

In some examples the user interaction layer 230 is a substantially continuous layer of a material such as glass or a plastics material overlying the actuator layer 220. The user interaction layer 230 may, in some examples, be provided as a screen or display capable of displaying a graphical representation of a keyboard or other user input device. Providing the user interaction layer 230 as a screen or display in this way is advantageous, as different key configurations can be presented simply by displaying different graphics, which makes it relatively simple to reconfigure the user input device 220 for different purposes. For example, the user input device 200 can switch between displaying key configurations for different languages, or between alphanumeric keys and symbols, by changing the key configuration graphic that is displayed.

In other examples the user interaction layer 230 may comprise a plurality of individual portions 232, each overlying, at least partially, one or more of the plurality of actuators 222. For example, as shown in FIG. 2b, each individual portion 232a-232d of the user interaction layer 230 may overlie a respective one 222a-222b of the plurality of actuators 222, such that each individual portion 232a-232d is associated with a respective one 232a-232d of the plurality of actuators 222. Thus, in the arrangement of FIG. 2b, each individual portion 232a-232d is akin to a keycap of a conventional mechanical keyboard.

Alternatively, each individual portion 232 of the user interaction layer 230 may be associated with two or more actuators 222 of the actuator layer 220. For example, as shown in FIG. 2c, a first individual portion 232a of the user interaction layer 230 may be arranged or positioned such that a first edge (e.g. a left-hand edge) thereof partially overlies a first actuator 222a and a second edge (e.g. a right-hand edge) thereof partially overlies an adjacent second actuator 222b. Similarly, in the example shown in FIG. 2c a second portion 232b partially overlies the second actuator 222b and an adjacent third actuator 222c, whilst a third portion 232c partially overlies the third actuator 222c and an adjacent fourth actuator 222d. Such an arrangement may permit a wider range of haptic effects to be generated for each of the individual portions 232 of the user interaction layer 230 than the one-to-one arrangement of actuators and user interaction layer portions shown in FIG. 2b, since each portion 232 can receive haptic outputs from two (or more) haptic actuators 222.

In some examples (particularly where the actuators 222 do not also perform a sensing function), the user interaction layer 230 may be a touch-sensitive or force-sensitive user input layer of the kind that will be familiar to those of ordinary skill in the art. In such arrangements, user inputs may be sensed or detected by the touch-sensitive or force-sensitive user input layer (in conjunction with the user input detection circuitry 240) and haptic feedback may be provided to the user by the actuators 222 of the actuator layer. In other examples in which the actuators 222 are configured to act as both input sensors and output actuators, user inputs may be sensed by the actuators 222 and haptic feedback may also be provided to the user by the actuators 222.

The user interaction layer 230 is provided with a key configuration such as the configuration illustrated in FIG. 1 (if the user input device 200 is for use as a keyboard).

The key configuration may be provided by printed, etched or other physical markings on the user interaction layer 230, and the user interaction layer 230 may be provided with physical features such as embossed or recessed lines delimiting the boundaries between adjacent keys of the key configuration. The user interaction layer 230 may further include physical features such as embossed or recessed formations (e.g. lines, dots or other shapes) to facilitate identification of particular keys by touch.

Alternatively, where the user interaction layer 230 is provided by a screen or display, the kay configuration may be provided as a graphic that is displayed by or on the user interaction layer 230 as described above.

The user input detection circuitry 240 is coupled to the user interaction layer 230 and/or to the actuator layer 220, depending on the functionality of the user interaction layer 230 and the actuator layer 220.

Thus, if the user interaction layer 230 comprises a touch-sensitive or force-sensitive layer, the user input detection circuitry 240 is coupled to the user interaction layer 230 and is configured to receive signals from the user interaction layer 230 and to calculate, estimate or otherwise determine parameters of a user input, based at least in part on the signals received from the user interaction layer 230.

For example, the user input detection circuitry 240 may be operative to determine parameters such as: the position(s) on the user interaction layer 230 at which one or more user inputs (e.g. touches) have been received; a duration of a user input; a pressure of a user input; a time between consecutive user inputs; a number of user inputs received in a predetermined period of time; the positions on the user interaction layer 230 of a plurality of user inputs received in a predetermined period of time; and the like.

Similarly, if the actuators 222 of the actuator layer are configured to act as user input sensors, the user input detection circuitry 240 is coupled to the actuator layer 220 and is configured to receive signals from the actuator layer 220 and to calculate, estimate or otherwise determine parameters of a user input, based at least in part on the signals received from the actuator layer 220. Again, the user input detection circuitry 240 may be operative to determine parameters such as: the position(s) on the user interaction layer 230 at which one or more user inputs (e.g. touches) have been received; a duration of a user input; a pressure of a user input; a time between consecutive user inputs; a number of user inputs received in a predetermined period of time; the positions on the user interaction layer 230 of a plurality of user inputs received in a predetermined period of time; and the like.

The processing circuitry 250 is coupled to the user input detection circuitry 240, and is configured to execute instructions (which may be stored, for example, in the memory 260) to process output signals from the user input detection circuitry 240 to determine the nature of one or more detected user inputs, e.g. if a detected user input corresponds to: a brief tap at a single position or location on the user interaction layer 230; an extended touch (e.g. a touch and hold) at a single position or location; a gesture such as a swipe, slide or rotation of one or more fingers; a multi-touch user input (e.g. a user input involving simultaneous contact by two or more fingers with the user interaction layer 230); a sequence of touches; or the like.

The processing circuitry 250 may, additionally or alternatively, execute instructions to determine other parameters of or associated with the user input, such as a duration of a user input session, e.g. by determining a total time that has elapsed since detection of a first user input on the user interaction layer 230 following activation (e.g. powering up) of the user input device 200.

The haptic output generation circuitry 270 is coupled to the processing circuitry 250, and is configured to generate a haptic output signal, or to retrieve a predefined haptic output signal (e.g. from a library of haptic signals or waveforms stored in the memory 260) to output to one or more of the haptic actuators 222, based on one or more signals output by the processing circuitry 260.

Thus, in use of the user input device 200, a sensation experienced by a user in response to their interaction with the user input device 200—i.e. their input to the user input device 200—may vary, depending upon one or more parameters or characteristics of, or associated with, the user input.

For example, if the user taps or touches a key portion of the user interaction layer 230 (i.e. a portion that corresponds to a displayed key of the key configuration) with a light pressure, the processing circuitry 250 may interpret this user input as a light tap and may thus output a signal that causes the haptic output generation circuitry 270 to generate or select a first haptic output signal of a relatively low amplitude to output to the haptic actuator(s) 222 that correspond(s) to the portion of the user interaction layer 230 that was touched or tapped, such that the user experiences a relatively weak haptic effect, which may simulate or represent the response of a conventional mechanical keyboard to a light tap input.

In contrast, if the user taps or touches a key portion with a heavier pressure, the processing circuitry 250 may interpret this user input as a heavier tap and may thus output a signal that causes the haptic output generation circuitry 270 to generate or select a second haptic output signal of a relatively higher amplitude to output to the haptic actuator(s) 222 corresponding to the portion of the user interaction layer 230 that was touched or tapped, such that the user experiences a stronger haptic effect, which may simulate or represent the response of a conventional mechanical keyboard to a heavier tap input.

In attempting to emulate the behaviour of a mechanical switch, the processing circuitry 250 may output one haptic event on detection of a user increasing pressure on a sensor (“switch pressed”); and on detection of decreasing pressure by the user removing the pressure, trigger a separate “switch released” haptic event before the user has completely removed their finger from surface.

In these examples, the haptic output signal selected or generated by the haptic output generation circuitry 270 varies based, at least in part, on the pressure of the user's input to the user input device.

Similarly, if the user taps or touches and then holds a key portion of the user interaction layer 230, the processing circuitry 250 may interpret this user input as a press and hold or long press input and may cause the haptic output generation circuitry 270 to generate or select a third haptic signal which changes over time to cause, in the user, an initial sensation of low resistance to movement (which may simulate the initial movement of a key when it is pressed) followed by a sensation of relatively constant resistance (which may simulate the subsequent resistance of the key to further movement after it has been fully depressed).

In this example, the haptic output signal selected or generated by the haptic output generation circuitry 270 varies based, at least in part, on the duration of the user's input to the user input device. The haptic output may take the form of a repeated or rhythmic pattern in response to the long press input.

Other different haptic effects which may simulate the sensations experienced by a user in use of a conventional mechanical keyboard can also be produced by the user input device 200, by generating or selecting appropriate haptic output signals to output to one or more of the actuators 222 in response to a detected user input.

By varying the haptic output that is provided by the user input device 200 according to a characteristic or parameter of a detected user input in this way, the user input device 200 may provide the user with tactile feedback that is similar to the tactile response of a conventional keyboard, which may help the user to adapt or become accustomed to using the user input device 200.

In addition to providing haptic outputs which may simulate the response of a conventional mechanical keyboard, the user interface device 200 may also provide different haptic outputs to provide additional information to a user of the user input device 200.

For example, if the user presses and holds a key portion of the user interaction layer 230 corresponding to a directional input key of the fourth set of keys 140 (e.g. to cause a display to scroll), the processing circuitry 250 may cause the haptic output generation circuitry 270 to generate or select a suitable haptic signal to supply to the relevant actuator 222 (e.g. one or more actuators 222 associated with the key portion that the user is pressing) to cause the user to experience a pulsed or scrolling sensation in the finger that is touching the key portion, or some other sensation that indicative or representative of the action that results from the user's press and hold input on the user interaction layer 230.

In this example, the haptic output signal selected or generated by the haptic output generation circuitry 270 varies based, at least in part, on the position on the user interaction layer 230 of the user's input, and on the duration of the user's input. Also, certain combinations of key presses may trigger haptic events in actuators adjacent to, but not necessarily touching the user's fingers or hand position.

As another example, if the user presses and holds more than one key portion of the user interaction layer 230 simultaneously, the processing circuitry 250 may cause the haptic output generation circuitry 270 to generate or select a suitable haptic signal to supply to the relevant actuators 222 (e.g. more actuators 222 associated with the key portions that the user is pressing) to cause the user to experience a pulsed or scrolling sensation (or some other sensation that indicative or representative of the action that results from the user's press and hold input on the user interaction layer 230) in the fingers that are touching the key portions. The haptic signal may be supplied to the actuators 222 on a time division multiplexed or time-sequenced basis, such that the user experiences the sensation in a first finger at a first time, in a second finger at a second, subsequent time, and a third finger at a third time, subsequent to the second time.

In this example, the haptic output signal selected or generated by the haptic output generation circuitry 270 varies based, at least in part, on the positions on the user interaction layer 230 of the user's inputs, and on the durations of the user's inputs.

The user input device 200 may, additionally or alternatively, provide different haptic feedback for different categories of keys. For example, if the user input device 200 provides a key configuration of the kind shown in FIG. 1, it may provide different haptic feedback for keys belonging to each the different sets of keys.

Thus, in one example, if the user input detection circuitry 240 detects a user input (touch, press etc.) on a key of the first set 110 (i.e. a user input on a portion of the user interaction layer 230 corresponding to a key of the first set 110), the haptic output generation circuitry 270 may generate or select a haptic output signal having a first set of parameters (e.g. a first amplitude and/or a first frequency and/or a first duration) to output to the appropriate one(s) of the actuators 222, whereas if the user input detection circuitry 240 detects a user input on a key of the second set 120, the haptic output generation circuitry 270 may generate or select a haptic output signal having a second set of parameters (e.g. a second amplitude and/or a second frequency and/or a second duration), in which at least one parameter is different to the corresponding parameter of the first set, to output to the appropriate one(s) of the actuators 222. Similarly, if the user input detection circuitry 240 detects a user input on a key of the third or fourth set 130, 140, the haptic output generation circuitry 270 may generate or select a haptic output signal having a third or fourth set of parameters, in which at least one parameter is different to the corresponding parameter of the first set, to output to the appropriate one(s) of the actuators 222.

Thus in this example, the haptic output signal selected or generated by the haptic output generation circuitry 270 varies based, at least in part, on the position on the user interaction layer 230 of the user's input.

Generating or selecting different haptic output signals according to the type of key that has received a user input in this way can provide instantaneous (or near instantaneous) user feedback as to the type of key (e.g. alphanumeric, function, modifier, directional etc.) that has been pressed, which may help to prevent typing errors or unintentional invocation of functions.

The user input device 200 may, additionally or alternatively, provide different haptic feedback when user inputs are received for two or more keys simultaneously or within a threshold period of time of each other.

In one example, if a first user input (e.g. a touch, press and hold etc.) is detected on a portion of the user interaction layer 230 corresponding to a modifier key such as a shift key, a haptic output signal having a third set of parameters may be generated or selected by the haptic output signal generation circuitry 270 and output to the relevant one(s) of the actuators 222, as discussed above. If a second user input is detected on a portion of the user interaction layer 230 corresponding to an alphanumeric key while the first user input is being detected, a haptic output signal having a fifth set of parameters (in which at least one parameter is different from the corresponding parameter of the first set) may be generated or selected by the haptic output signal generation circuitry 270 and output to the relevant one(s) of the actuators 222, to provide an indication to the user that, e.g. an upper-case letter has been selected in response to the second user input.

Thus in this example, the haptic output signal selected or generated by the haptic output generation circuitry 270 varies based, at least in part, on the positions on the user interaction layer 230 of the user's inputs, and on the duration of at least one of the user's inputs.

As another example, if the user presses or touches two or more different portions of the user interaction layer 230 that correspond to different keys simultaneously or within a predetermined period of time of each other, in order to invoke a shortcut to a particular function of a software application (e.g. a word processor, spreadsheet or the like) that is executing on a host device that incorporates or is otherwise coupled to or uses the user input device 200, e.g. if the user simultaneously presses a portion corresponding to a “Control” key of the third set of keys 130 and a portion corresponding to an “S” key of the first set of keys to invoke a “save” function of the software application, the processing circuitry 250 may receive a signal from the host device, generated in accordance with the requirements of the software application, to cause the haptic output signal generation circuitry 270 to generate or select haptic output signals having a further different set of parameters (in which at least one parameter is different from the corresponding parameter of the first set) to supply to the actuators 222 associated with the portions of the user interaction layer 230 that the user is pressing or touching, in order to provide tactile feedback to the user to confirm that the shortcut has been invoked. Thus, in the example described above in which the user invokes a save function, on detection of the two user inputs the software application may receive notification of the locations of the user inputs and may respond by i) invoking the save function and ii) providing an appropriate indication (e.g. a flag) to cause the haptic output signal generation circuitry 270 to generate or select the haptic output signals to drive the actuators 222 associated with the portions of the user interaction layer 230 that are currently being touched by the user, in order to provide tactile confirmation that the save function has been invoked.

Similarly, if first and second user inputs are detected simultaneously or within a threshold period of time of each other on portions of the user interaction layer 230 corresponding to neighbouring alphanumeric keys (e.g. on portions corresponding to the Q and W keys of the key configuration of FIG. 1), the processing circuitry 250 may interpret the detected user inputs as a possible typing error, and may cause the haptic output signal generation circuitry 270 to generate or select a haptic output signal having a further different set of parameters (in which at least one parameter is different from the corresponding parameter of the first set), in order to provide an indication to the user that a possible typing error has been detected.

The user input device 200 may be configured such that the haptic outputs that are provided in response to different user inputs (e.g. different touch pressures, speeds, durations etc., different combinations of keys) can be selected or configured by a user of the user input device 200, e.g. through a software application such as a driver that causes a user's preferred settings for the haptic outputs to be stored in the memory 260.

The user input device 200 may also be configured such that input characteristics or parameters of the user input device 200, such as a sensitivity of the user interaction layer 230 and/or individual portions thereof are user selectable or configurable, e.g. through a software application such as a driver that causes a user's preferred settings for the input characteristics or parameters to be stored in the memory 260.

Additionally or alternatively, the user input device 200 may be configured to develop a profile representing a user's preferred settings for the haptic outputs and/or the input characteristics of the user input device 200. The processing circuitry 250 may thus execute instructions to monitor and/or record a user's interactions with the user input device 200 over a predetermined period of time in order to determine parameters such as, for example, a typical speed and/or pressure and/or duration of the user's inputs on the user input layer 230, and/or a typical positioning of the user's fingers on the user interaction layer 230 while performing user inputs and/or at rest (e.g. between user inputs).

Based on the monitored or recorded parameters, the processing circuitry 250 may develop the profile, which may be stored in the memory 260 (e.g. as a file). The profile may be “portable”, in the sense that it may be transferrable to other user input devices 200, to enable such devices to be configured quickly in accordance with the user's preferences.

Further, the user input device 200 may be configured to develop and store profiles for different users (e.g. in the memory 260) and to permit selection of a stored user profile in order to configure the user input device 200 quickly to in accordance with the preferences of a particular user.

By developing profiles for individual users in this way, the user input device 200 can be tailored or optimised for a user, to provide an improved user experience, e.g. in terms of speed, comfort or other characteristics.

One common observation among users of virtual keyboards or “zero displacement” keyboards (i.e. keyboards in which there is no movement, or very limited movement, of individual key portions of the keyboard in response to user inputs such as keypresses, touches or taps) is that it can take time to become accustomed to the lack of any tactile feedback from the (solid state) keyboard. However, after a period of “acclimatisation” or habituation, use of the keyboard with a reduced amount of tactile feedback feels natural.

To aid users with the process of acclimatisation or habituation to a virtual keyboard, the user input device 200 may be configured to adjust, over time, the amplitude of the haptic output signals that are used to drive the actuators 222 (in response to user inputs on the user interaction layer 230), such that during an initial period of use of the user input device 200 (e.g. for a predetermined period of time after the user input device 200 is powered on, or for a predetermined period of time after a first user input is detected) the amplitude of the haptic output signals is at a first, relatively high level. Subsequently, the amplitude of the haptic output signals is progressively reduced (e.g. in a series of downward steps) over a predetermined time period during use of the user input device 200, until a final, lower amplitude is reached. In some examples, the final amplitude may be zero, such that after the predetermined time period no haptic output signal is provided in response to a user input.

Progressively reducing the amplitude of the haptic output signals over time in this way may help a user to acclimatise to using the user input device 200, when transitioning from a mechanical switch based keyboard. The user input device 200 may be configured to perform this progressive adjustment of the amplitude of the haptic output signals for every user input session, e.g. every time the user input device 200 is powered on, or when a user input is detected after a predetermined relatively long period (e.g. an hour or more) of inactivity.

In addition to (or as an alternative to) providing tactile feedback to a user of the user input device 200 in response to user inputs, the actuators 222 may also provide tactile feedback for other events such as errors, warnings and the like.

For example, the user input device 200 may sense (e.g. using the user interaction layer 230 and/or using the actuators 222, if the actuators 222 are configured to perform a sensing function) the position of one or more of a user's fingers on the user interaction layer 230, and may provide haptic output signals to the actuators 222 associated with or close to those position(s) in order to provide tactile notifications to the user of alerts, warnings, error conditions or the like. For example, if the battery of a host device (e.g. a laptop computer) incorporating the user input device 200 is at a low state of charge, the host device may issue a low battery notification, and the processing circuitry 250 may cause the haptic output generation circuitry 270 to select a haptic output signal to output to the actuators 222 associated with or close to the positions on the user interaction layer 230 at which the user's fingers are located, such that the user receives a tactile notification through their fingers of the low battery state of the host device.

Alternatively, the haptic output signal may be supplied to one or more actuators 222 at positions corresponding to a position of an alert or warning that is displayed on a screen of a host device incorporating or using the user input device 200, or to one or more of the actuators 222 that are associated with or close to the positions of the user's fingers and that most closely correspond to the position of the displayed alert, notification or warning. For example, if the alert or warning is displayed in a lower left-hand portion of the screen, then the lower left-most actuator(s) of the actuators 222 that are associated with or close to the positions of the user's fingers may be supplied with a suitable haptic output signal by the haptic output generation circuitry 270, which may cause the user to direct their gaze to the corresponding portion of the screen, where the alert, notification or warning is displayed.

As a further alternative, the haptic output generation circuitry 270 may sequentially output haptic output signals to a selected set of two or more actuators 222 to generate a sensation similar to a ripple propagating through the user interaction layer 230 in order to provide tactile feedback representative of an alert, warning or error condition of the host device. For example, for a “low battery” warning or alert that appears in the lower right-hand portion of the screen, the haptic output generation circuitry 270 may sequentially output haptic output signals to two or more actuators 222 in a lower right-to-upper left directional order, in order to generate a sensation similar to a ripple that propagates from the lower right-hand side of the user interaction layer 230 to the upper left-hand side of the user interaction layer 230. In some examples the user input device 200 may detect the positions of the user's fingers on the user interaction layer 230, and may output the haptic output signals only to the actuators 222 associated with the detected positions, in an appropriate order or sequence and at appropriate amplitudes to generate the rippling sensation in the user's fingers.

As will be appreciated by those of ordinary skill in the art, a variety of different haptic output signals may be selected or generated by the haptic output generation circuitry 270 for output to the actuators 222 in response to different warnings, alerts or error conditions, and one or more parameters of the haptic output signals (e.g. an amplitude, a frequency, a duration or a duty cycle) may be variable based on the warning, alert or error condition.

In addition to (or as an alternative to) providing haptic or tactile feedback to a user of the user input device 200, the user input device 200 may also be operable to provide audible outputs, so as to provide audible feedback to the user of the user input device 200.

For example, if the actuators 222 are piezoelectric actuators, then any actuator 222 that is not being used to provide a haptic output may instead be used to provide an audible output. Thus, in addition to providing haptic output signals to the actuators 222 that are to be used to provide a haptic output (e.g. in response to a user input or an alert, warning or error condition as described above), the haptic output generation circuitry 270 may also generate or select (e.g. from the memory 260) an appropriate audio output signal to supply to one or more of the actuators that are not being used to provide a haptic output. As an example, in response to a tap or touch user input on the user interaction layer 230, the haptic output generation circuitry 270 may output an audio signal to a selected set of one or more of these unused actuators 222 to cause the set of unused actuators 222 to output a simple beep or click sound, in addition to supplying a suitable haptic output signal to those of the actuators 222 that are to provide a haptic output in response to the user input.

More complex audio outputs may also be provided, in response to a user input or an alert, warning or error condition. For example, if the user presses and holds a portion of the user interaction layer 230 corresponding to an directional key of the fourth set of keys 140, in addition to outputting a haptic signal to the appropriate one(s) of the actuators as described above, the haptic output generation circuitry 270 may also sequentially output audio signals to a selected set of two or more actuators 222 that are not being used to provide the haptic output, in a sequence the reflects the direction of the directional key—e.g. if a portion corresponding to a down arrow key is pressed by the user, the audio signal may be output to the selected set of transducers 222 in a sequence starting at an uppermost one of the selected set of transducers 222 and ending at a lowermost one of the selected set of transducers 222.

Similarly, if an alert, notification or warning is displayed on a screen of a host device incorporating or using the user interface device 200, a corresponding audio signal may be selected or generated by the haptic output generation circuitry 270 and output to a selected set of actuators 222 that are not being used for haptic output and are located in a region of the user interface device corresponding to the region of the screen at which the alert, notification or warning is displayed. For example, if the alert, warning or notification is displayed in a lower left-hand portion of the screen, the audio signal may be output to a selected set of actuators 222 in a lower left-hand portion of user input device 200, so as to produce an audible output to prompt the user to look at the on-screen alert, notification or warning. Those skilled in the art will be aware that appropriate phase and amplitude manipulation of audio signals to a set of planar transducers can create wide acoustic images and stereo effects to a user situated in close proximity and on axis with the keyboard surface.

In some examples, the haptic actuators 222 of the actuator layer 220 may perform a cleaning function, in which the processing circuitry 250 causes the haptic output generation circuitry 270 to generate a cleaning output signal, or to retrieve a predefined cleaning output signal, to output to one or more of the haptic actuators 222, to cause the one or more haptic actuators 222 to perform the cleaning function.

Thus, the user input device 200 may be operable in a first, “normal”, mode of operation and a second, “cleaning” mode of operation.

In the normal mode of operation, a first set of haptic waveforms or signal frequencies (which may be predefined and stored, e.g. in the memory 260, or may be dynamically generated, e.g. in response to user inputs on the user interaction layer 230) are used to drive the haptic transducers 222 to generate haptic outputs.

In the cleaning mode of operation, a second set of haptic waveforms or signal frequencies (which may also be predefined and stored, e.g., in the memory 260, or may be dynamically generated) are used as one or more cleaning output signals to drive the haptic transducers 222 to perform the cleaning function.

The user input device 200 may switch from the normal mode of operation to the cleaning mode of operation in response to a trigger condition such as a signal or flag received by the user input device 200 (or a component or subsystem thereof, e.g. the processing circuitry 250) from an external controller such as an applications processor of a host device such as a mobile telephone that incorporates the user input device.

For example, in response to the cleaning output signal, the one or more of the haptic actuators 222 may vibrate at a particular frequency or a set or range of frequencies for a predetermined period of time to loosen and/or displace debris such as dead skin, food crumbs and the like that may have settled on the user interaction layer 230, to move such debris off the user interaction layer 230, or facilitate removal of such debris.

In another example, the cleaning output signal may cause the different ones or different groups of the haptic actuators 222 to vibrate at a particular frequency, set of frequencies or range of frequencies in a predetermined sequence (e.g. in a left-to-right or a top-to-bottom order) to displace liquid from the surface of the user interaction layer 230.

This cleaning function may be invoked periodically (e.g. once per day), or on demand by a user of the user input device 200, e.g. in response to a particular command. Additionally or alternatively, if the user input device 200 has sensing capabilities that enable it to sense a spillage of liquid on the user interaction layer (e.g. by detecting a change in a capacitance of one or more of the haptic actuators 222 resulting from the presence of liquid in the vicinity of the actuator 222), the cleaning function may be invoked automatically on detection of the presence of liquid, to cause the haptic actuator(s) 222 in the vicinity of the spill to vibrate as described above to displace the spill.

In some examples the haptic actuators 222 of the actuator layer 220 may be operable as an array of ultrasonic transmitters and/or sensors, which can be used for detecting a proximity of an object, recognition of user gestures (e.g. hand gestures performed in the air above the user interaction layer 230) and the like.

Thus, the processing circuitry 250 may cause the haptic output generation circuitry 270 to generate an ultrasonic sensor output signal or a set of ultrasonic sensor output signals, or to retrieve a predefined ultrasonic sensor output signal or a set of ultrasonic sensor output signals, to output to one or more of the haptic actuators 222, to cause the haptic actuators 222 to act as an ultrasonic transmitter/sensor array. Based on reflected ultrasonic signals detected by the haptic actuators 222, proximity of an object, user gestures and the like can be detected.

The ultrasonic output signal or set of ultrasonic sensor output signals output to the plurality of haptic actuators 222 may be selected or generated to achieve any desired beamforming effect in the ultrasonic signals output by the haptic actuators 222. For example, the ultrasonic output signal or set of ultrasonic sensor output signals may cause the ultrasonic signals output by the haptic actuators 222 to be focused on a particular region or point at a particular distance from the user interaction layer 230. Alternatively, the ultrasonic output signal or set of ultrasonic sensor output signals may cause the ultrasonic signals output by the haptic actuators 222 to cover an area corresponding to a surface area of the user interaction layer 230. Those of ordinary skill in the art will readily appreciate that beamforming techniques may be applied in generating the ultrasonic sensor output signals used to drive the plurality of haptic transducers 222 in order to achieve any desired beamforming effect.

In the foregoing description and FIG. 2a the user input detection circuitry 240, processing circuitry 250 and haptic output generation circuitry 270 are shown as separate modules. However, as will be appreciated by those of ordinary skill in the art, the user input detection circuitry 240, processing circuitry 250 and haptic output generation circuitry 270 may alternatively be implemented as a single module (e.g. a processor executing appropriate instructions) that provides the functionality of all of the individual modules.

In some examples the user input device 200 may include an integrated circuit (IC) having a force sensing front end and an output driver for implementing the above-described functionalities. The force sensing front end is configured to receive a signal from a keyboard transducer and the output driver is configured to drive a haptic signal to the keyboard transducer.

For example, the user input detection circuitry 240, processing circuitry 250, haptic output generation circuitry 270 and possibly also memory 260 may be provided in a single IC 280. In such an example, the force sensing front end comprises the user input detection circuitry 240 and the output driver comprises the haptic output generation circuitry 270.

The foregoing description and the accompanying drawings describe and illustrate the user input device of the present disclosure as an alphanumeric keyboard, but it will be appreciated that the user input device could be implemented in many different ways, e.g. as a numeric keypad for use, e.g. in an ATM (automated teller machine) or a PIN pad for a point of sale terminal or the like. Thus the present disclosure is not limited to alphanumeric keyboards but also extends to other user input devices.

The user input device may be incorporated in a host device such as a laptop, notebook, netbook or tablet computer, a mobile telephone, a portable device, or may constitute or be incorporated in an accessory device for use with a laptop, notebook, netbook or tablet computer, a mobile telephone, or a portable device.

The skilled person will recognise that some aspects of the above-described apparatus and methods may be embodied as processor control code, for example on a non-volatile carrier medium such as a disk, CD- or DVD-ROM, programmed memory such as read only memory (Firmware), or on a data carrier such as an optical or electrical signal carrier. For many applications, embodiments will be implemented on a DSP (Digital Signal Processor), ASIC (Application Specific Integrated Circuit) or FPGA (Field Programmable Gate Array). Thus the code may comprise conventional program code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re) programmable analogue array or similar device in order to configure analogue hardware.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single feature or other unit may fulfil the functions of several units recited in the claims. Any reference numerals or labels in the claims shall not be construed so as to limit their scope.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

1-30. (canceled)

31. A solid state keyboard device comprising:
a user interaction layer for receiving a user input; and
a plurality of haptic actuators,
wherein the solid state keyboard device is operable to cause one or more of the plurality of haptic actuators to generate a haptic output at the user interaction layer in response to the received user input,
and wherein one or more of the plurality of haptic actuators is operable as an ultrasonic transmitter and/or an ultrasonic sensor.

32. The solid state keyboard device of claim 31, further comprising:
output generation circuitry configured to:
generate an ultrasonic output signal or a set of ultrasonic output signals to supply to the one or more of the plurality of haptic actuators; or
retrieve a predefined ultrasonic output signal or a set of ultrasonic output signals to supply to the one or more of the plurality of haptic actuators.

33. The solid state keyboard device of claim 32, wherein the ultrasonic output signal or the set of ultrasonic output signals is generated or selected to achieve a beamforming effect.

34. The solid state keyboard device of claim 31, further configured to detect proximity of an object or a user gesture based on a reflected ultrasonic signal detected by the one or more of the plurality of haptic actuators.

35. The solid state keyboard device of claim 31, wherein one or more parameters of the haptic output are variable according to one or more parameters of or associated with the received user input.

36. The solid state keyboard device of claim 35, wherein the one or more parameters of or associated with the received user input comprise one or more of:
one or more positions of the received user input on the user interaction layer;
a pressure of the received user input;
a speed of the received user input;
a duration of the received user input; and
a duration of a user input session.

37. The solid state keyboard device of claim 35, wherein the one or more parameters of the haptic output comprise one or more of:
an amplitude;
a frequency;
a duration; and
a duty cycle.

38. The solid state keyboard device of claim 31, wherein the plurality of haptic actuators comprise piezoelectric actuators and/or electrostatic actuators.

39. The solid state keyboard device of claim 31, wherein the plurality of haptic actuators are configured to generate an electrical signal in response to a user input.

40. The solid state keyboard device of claim 31, wherein the user interaction layer comprises a substantially continuous layer or a plurality of individual portions.

41. The solid state keyboard device of claim 40, wherein each individual portion of the plurality of individual portions is associated with two or more of the plurality of haptic actuators.

42. The solid state keyboard device of claim 40, wherein each individual portion of the plurality of individual portions is associated with a respective one of the plurality of haptic actuators.

43. The solid state keyboard device of claim 31, wherein the user interaction layer comprises a touch-sensitive or force-sensitive layer.

44. The solid state keyboard device of claim 32, further comprising user input detection circuitry configured to determine the one or more parameters of or associated with the received user input.

45. The solid state keyboard device of claim 44, further comprising processing circuitry configured to process a signal output by the user input detection circuitry to determine, based on the signal output by the user input detection circuitry, a nature of a detected user input.

46. The solid state keyboard device of claim 45, further comprising haptic output generation circuitry configured to generate a haptic output signal or to retrieve from memory a predefined haptic output signal for output to a first set of one or more of the plurality of haptic actuators, based on a signal output by the processing circuitry.

47. The solid state keyboard device of claim 46, wherein the haptic output generation circuitry is further configured to generate an audio output signal or to retrieve from memory a predefined audio output signal for output to a second set of one or more of the plurality of haptic actuators, different than the first set, based on a signal output by the processing circuitry.

48. The solid state keyboard device of claim 31, wherein the solid state keyboard device is operative to monitor or record a user's interactions with the solid state keyboard device over a predetermined period of time to develop a profile for the user.

49. The solid state keyboard device of claim 48, wherein the solid state keyboard device is configured to reduce an amplitude of the haptic output from a first, relatively higher level, to a final, relatively lower level, over the predefined period of time.

50. The solid state keyboard device according to claim 31, wherein the solid state keyboard device is operable to cause one or more of the plurality of haptic actuators to generate a haptic output at the user interaction layer in response to an alert, warning or error condition of a host device incorporating or using the solid state keyboard device.

51. The solid state keyboard device of claim 50, wherein one or more parameters of the haptic output are variable according to the alert, warning or error condition of the host device, wherein the one or more parameters of the haptic output comprise one or more of:
an amplitude;
a frequency;
a duration; and
a duty cycle.

52. A host device comprising the solid state keyboard device of claim 31, wherein the host device comprises a laptop, notebook, netbook or tablet computer, a mobile telephone, a portable device, or an accessory device for use with a laptop, notebook, netbook or tablet computer, a mobile telephone, or a portable device.

53. A keyboard comprising:
a plurality of haptic actuators, wherein one or more of the plurality of haptic actuators is operable as an ultrasonic transmitter and/or an ultrasonic sensor; and
a single integrated circuit comprising:
force-sensing front end circuitry configured to receive a signal from one or more of the plurality of haptic actuators; and
output driver circuitry, wherein the output driver circuitry is configured to supply a haptic drive signal to one or more of the plurality of haptic actuators.
